(19) United States
(12) Patent Application Publication
(10) Pub. No.: US 2006/0120246 A1
(43) Pub. Date: Jun. 8, 2006

(54) Optical pickup head for optical recording media

(75) Inventor: Wen-Hhin Sun, Tucheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/077,944

(22) Filed: Mar. 11, 2005

(30) Foreign Application Priority Data
Dec. 3, 2004 (TW) 93106639

(51) Int. Cl. G11B 7/00

(52) U.S. Cl. 369/112.01; 369/44.23

(57) ABSTRACT

An optical pickup head for optical recording media includes a diffracting element disposed, a reflective multi-surface prism disposed beside and coaxially facing said the other side of the diffracting element, a collimating lens disposed beside and coaxially facing to the penetrative emergent surface of the prism for condensing the laser beam therethrough, a optical path changer disposed at a certain oblique angle the pentagonal prism, and an objective lens facing an optical recording media for converging the reflected laser beam therethrough onto the optical recording media. An axis defined by the diffracting element and an incident surface of the prism, an axis defined by the emergent surface of the prism and the collimating lens, and an axis of the objective lens are all perpendicular to one another. This enables the three dimensions (X, Y, and Z) of the optical pickup head to be advantageously proportioned.

### BACKGROUND OF THE INVENTION

1. Field of the Invention

The present invention generally relates to optical pickup heads for optical recording media, and particularly to an optical pickup head adapted to record and/or reproduce signals onto and/or from an optical recording medium.

2. Prior Art

Along with advances in computer technology, optical recording media such as CDs (Compact Disks), VCDs (Video Compact Disks) and DVDs (Digital Video/Versatile Disks) have become necessities for entertainment and information storage in the daily life of many people.

An optical pickup head of an optical reader/writer carries out recording and/or reproducing of information such as video, audio or other data onto and/or from an optical recording medium. A conventional optical pickup head 1 is illustrated in FIG. 4. The optical pickup head 1 comprises a laser diode 10, a collimating lens 12, a reflecting mirror 13, and an objective lens 14 positioned directly opposite an optical recording medium (not shown). The laser diode 10 is used for generating a laser beam propagating toward the collimating lens 12. The laser beam is collimated by the collimating lens 12, and the resulting parallel laser beam propagates toward the reflecting mirror 13. The reflecting mirror 13 is positioned at a certain obliquity relative to the objective lens 14, for deflecting a propagation direction of the parallel laser beam received from the collimating lens 12. Generally, an axis of the objective lens 14 and an axis of the collimating lens 12 are perpendicular to each other; therefore the obliquity is 45°. The reflected laser beam is converged to a focused spot on an optical recording medium by the objective lens 14.

In the optical pickup head 1, the laser diode 10 should be disposed at a focal point of the collimating lens 12, so that the laser beam emitted by the laser diode 10 is converted into the parallel laser beam. The focal length of the collimating lens 12 depends on a thickness and a numerical aperture thereof. Generally, the focal length of the collimating lens 12 is about 20 millimeters. That is, a length of the optical system of the optical pickup head 1 along the X direction is much greater than a length thereof along the Y direction.

Generally, in an optical recording and/or reproducing apparatus, the X direction accords with a radial direction of an optical recording medium, and the Y direction accords with a tangential direction of the optical recording medium. Therefore, a feeding length of the optical recording and/or reproducing apparatus should be very large, in order that the optical pickup head can track between an interior and an exterior of the optical recording medium. This limits miniaturization and portability of optical recording and/or reproducing apparatuses.

### SUMMARY OF THE INVENTION

Accordingly, an object of the present invention is to provide a miniaturized and compact optical pickup head for optical recording media.

To achieve the above object, an optical pickup head for optical recording media in accordance with the present invention comprises: a diffracting element allowing a laser beam entering from one side thereof to directly propagate therethrough, and deflecting a laser beam entering from another side thereof; a reflective multi-surface prism disposed beside and coaxially facing the other side of the diffracting element, the prism including an incident surface directly facing the diffracting element, an emergent surface perpendicular to the incident surface, and at least one reflective surface; a collimating lens disposed beside and directly facing the emergent surface of the prism, for condensing and transforming an incident laser beam into a parallel laser beam; an optical path changer disposed beside and oriented at a predetermined inclined angle relative to the collimating lens, for deflecting a transmission direction of the parallel laser beam to another transmission direction; and an objective lens adapted to substantially directly face an optical recording medium, for converging the parallel laser beam onto the optical recording medium. The configuration of the optical pickup head enables the three dimensions (X, Y, and Z) of the optical pickup head to be advantageously proportioned.

### BRIEF DESCRIPTION OF THE DRAWINGS

Other objects, advantages and novel features of the present invention will be drawn from the following detailed description of preferred embodiments of the present invention with the attached drawings, in which:

FIG. 1 is an isometric view of an arrangement of an optical pickup head for optical recording media according to a first embodiment of the present invention;

FIG. 2 is a top plan view of part of the optical pickup head of FIG. 1, schematically showing essential optical path thereof; and

FIG. 3 is an isometric view of an arrangement of an optical pickup head for optical recording media according to a second embodiment of the present invention.

### DETAILED DESCRIPTION OF THE INVENTION

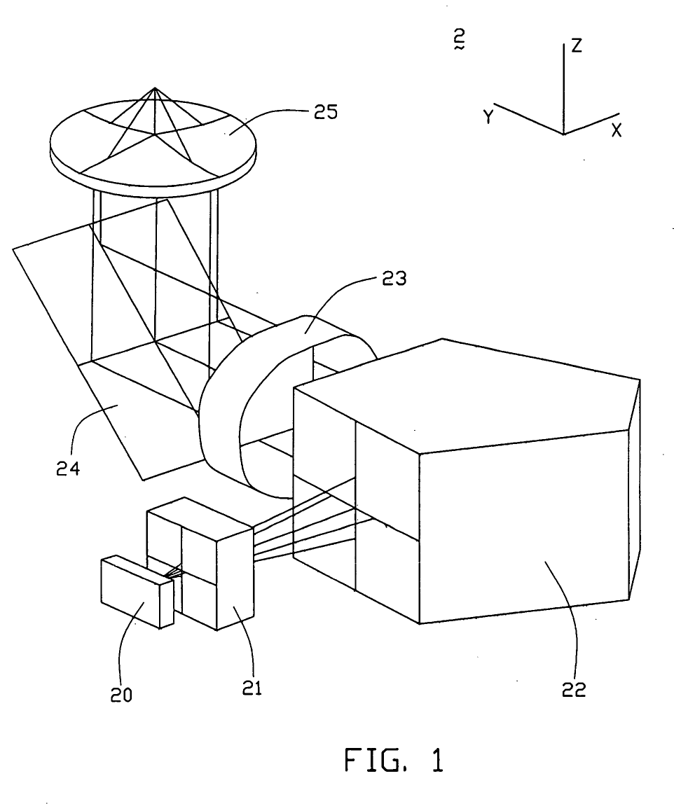

Referring to FIG. 1, an optical pickup head 2 for optical recording media according to the first embodiment of the present invention is illustrated. The optical pickup head 2 sequentially comprises a semiconductor module 20 for emitting and receiving a laser beam, a diffraction grating 21, a pentagonal prism 22, a collimating lens 23, a reflecting mirror 24, and an objective lens 25 directly facing an optical disk (not shown) for focusing incident beams onto the optical disk.

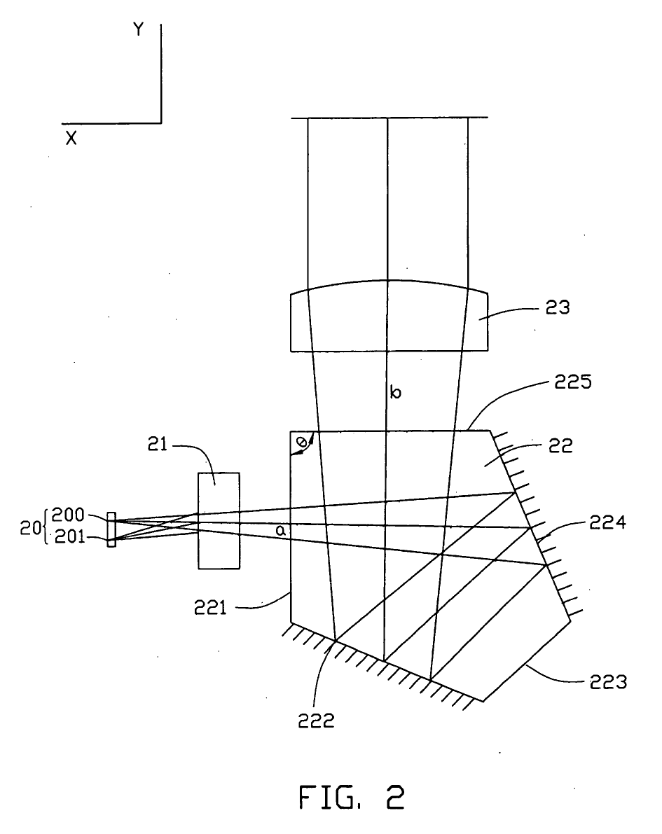

Also referring to FIG. 2, the semiconductor module 20 integrates a light source 200 with a photo detector 201. The light source 200 generates a laser beam (not labeled) with a specific wavelength compatible with a specific optical recording medium, while the photo detector 201 receives a corresponding laser beam returned from the optical recording medium.

The pentagonal prism 22 is a reflective type prism, and comprises five adjacent surfaces: a first surface 221, a second surface 222, a third surface 223, a fourth surface 224, and a fifth surface 225. The first surface 221 facing the diffraction grating 21 is an incident surface receiving an emitted laser beam of the light source 200, while the fifth surface 225 facing the collimating lens 23 is an emergent surface of the emitted laser beam. The first surface 221 and the fifth surface 225 are perpendicular to each other, and the other four included angles of the pentagonal prism 22 are preferably 112.5 degrees. With this configuration, a transmission direction of an incident laser beam from the first surface 221 is deflected from its original direction, and an emergent direction of the laser beam is perpendicular to the incident direction of the laser beam after the laser beam is reflected by the second and fourth surfaces 222, 224. That is, an incident axis ‘a’ defined by the first surface 221 is perpendicular to an emergent axis ‘b’ defined by the fifth surface 225.

The diffraction grating 21 is disposed between the semiconductor module 20 and the first surface 221 of the pentagonal prism 22, and is oriented perpendicular to the axis ‘a’ defined by the first surface 221 of the pentagonal prism 22. The diffraction grating 21 allows a laser beam entering from one side thereof to directly propagate therethrough, and diffracts a laser beam entering from the other side thereof. The collimating lens 23 is disposed between the fifth surface 225 of the pentagonal prism 22 and the reflecting mirror 24, and is oriented perpendicular to the axis ‘b’ defined by the fifth surface 225 of the pentagonal prism 22. The reflecting mirror 24 is oriented at a certain angle to both the collimating lens 23 and the objective lens 25, to change a transmission direction of an incident laser beam and make the laser beam perpendicularly transmit toward the objective lens 25. In the illustrated embodiment, the angle is 45°.

When recording an information signal onto and/or reproducing an information signal from an optical disk such as a DVD, the light source 200 emits a laser beam having a wavelength of about 650 nm. The laser beam propagates through the diffraction grating 21 along its original direction, and enters the pentagonal prism 22 through the first surface 221. In the pentagonal prism 22, the laser beam is reflected by the fourth surface 224 and the second surface 222, and exits the pentagonal prism 22 from the fifth surface 225. After exiting the pentagonal prism 22, the laser beam transmits into the collimating lens 23. The laser beam is condensed by the collimating lens 23 and transformed into a parallel laser beam. The parallel laser beam transmits to the reflecting mirror 24, and changes its transmission direction toward the objective lens 25. The objective lens 25 converges the parallel laser beam and forms a light spot on a certain position of the DVD.

After forming the light spot on the DVD, the DVD reflects the laser beam, so as to form a return laser beam. The return laser beam sequentially passes sequentially passes through/from the objective lens 25, the reflecting mirror 24, the collimating lens 23, and the pentagonal prism 22, and reaches the diffraction grating 21. The diffraction grating 21 diffracts the return laser beam toward the photo detector 201 of the semiconductor module 20. The photo detector 201 receives the return laser beam, and translates the return laser beams into corresponding electrical signals.

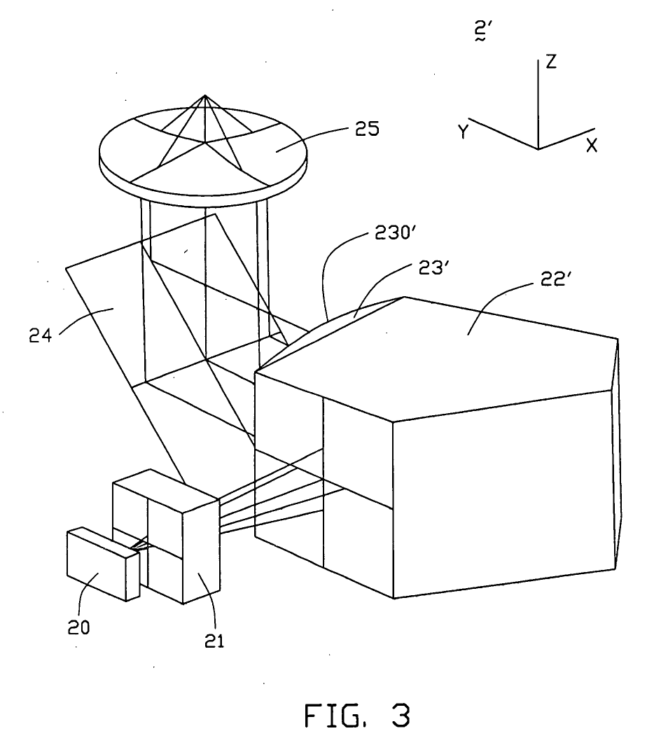

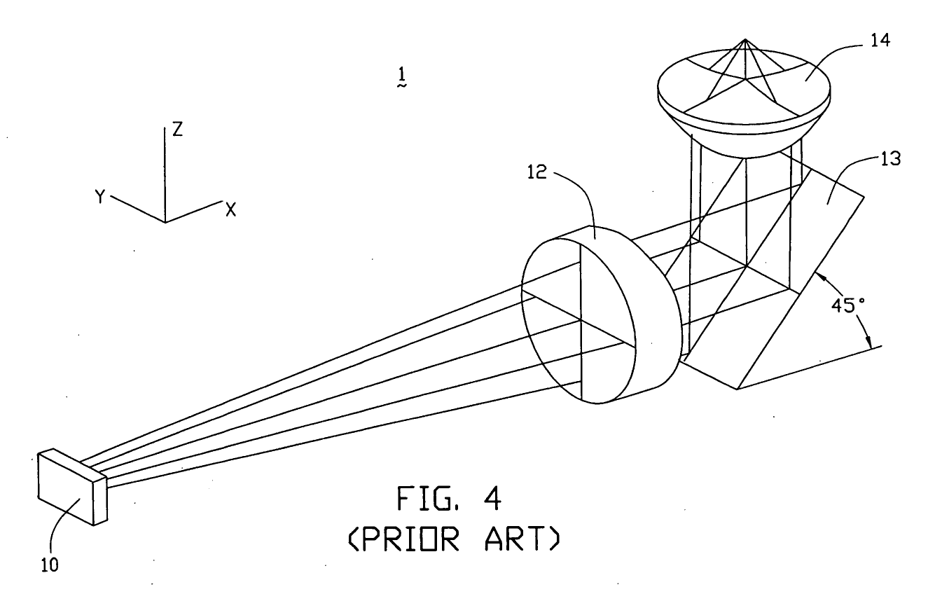

Now referring to FIG. 3, an optical pickup head 2′ for optical recording media according to the second embodiment of the present invention is illustrated. The optical pickup head 2′ sequentially comprises a semiconductor module 20, a diffraction grating 21, a pentagonal prism 22′, a collimating lens 23′, a reflecting mirror 24, and an objective lens 25. The optical pickup head 2′ has a structure similar to that of the optical pickup head 2, except that the pentagonal prism 22′ and the collimating lens 23′ are integrally formed as a compound prism. The collimating lens 23′ with an aspherical surface 230′ is adhered to a fifth surface (not labeled) of the pentagonal prism 22′. The aspherical surface 230′ faces the reflecting mirror 24 to collimate an incident laser beam.

An incident optical path and a return optical path of the optical pickup head 2′ are similar to the incident optical path and the return optical path of the optical pickup head 2.

In the above-described preferred embodiments, the reflecting mirror 24 forms a 45 degrees angle relative to the axis ‘b’ of the emergent surface of the pentagonal prism 22 (or 22′). Therefore, the incident laser beam and the reflected laser beam are perpendicular to each other. As a result, an axis of the diffraction grating 21, an axis of the collimating lens 23 (or 23′), and an axis of the objective lens 25 are all perpendicular to one another other. The three dimensions (X, Y, and Z) of the optical pickup head 2 (or 2′) are advantageously proportioned.

Furthermore, in alternative embodiments, the pentagonal prism 22 (or 22′) can be replaced by another kind of multi-faceted prism, such as a tetragonal prism or a hexangular prism, as long as an incident surface of the prism is not parallel to an emergent surface of the prism.

Although the present invention has been described with reference to specific embodiments, it should be noted that the described embodiments are not necessarily exclusive, and that various changes and modifications may be made to the described embodiments without departing from the scope of the invention as defined by the appended claims.

What is claimed is:

1. An optical pickup head for optical recording media, comprising:
a diffracting element allowing a laser beam entering from one side thereof to directly propagate therethrough, and deflecting a laser beam entering from another side thereof;
a reflective multi-surface prism disposed beside and coaxially facing the other side of the diffracting element, the prism including an incident surface directly facing the diffracting element, an emergent surface perpendicular to the incident surface, and at least one reflective surface;
a collimating lens disposed beside and directly facing the emergent surface of the prism, for condensing and transforming an incident laser beam into a parallel laser beam;
an optical path changer disposed beside and oriented at a predetermined inclined angle relative to the collimating lens, for deflecting a transmission direction of the parallel laser beam to another transmission direction; and
an objective lens adapted to substantially directly face an optical recording medium, for converging the parallel laser beam onto the optical recording medium.

2. The optical pickup head for optical recording media as recited in claim 1, wherein an axis defined by the diffracting element and the incident surface of the prism, an axis defined by the emergent surface of the prism and the collimating lens, and an axis of the objective lens are all perpendicular to one another.

3. The optical pickup head for optical recording media as recited in claim 2, wherein the prism is a pentagonal prism.

4. The optical pickup head for optical recording media as recited in claim 3, wherein the incident surface and the emergent surface of the pentagonal prism are adjacent to each other.

5. The optical pickup head for optical recording media as recited in claim 4, wherein the other four included angles of pentagonal prism are each 112.5 degrees.

6. The optical pickup head for optical recording media as recited in claim 5, wherein the collimating lens is attached to the emergent surface of the pentagonal prism.

7. The optical pickup head for optical recording media as recited in claim 1, wherein the collimating lens is attached to the emergent surface of the prism.

8. The optical pickup head for optical recording media as recited in claim 7, wherein the prism is a pentagonal prism.

9. The optical pickup head for optical recording media as recited in claim 8, wherein an axis defined by the diffracting element and the incident surface of the prism, an axis defined by the emergent surface of the prism and the collimating lens, and an axis of the objective lens are all perpendicular to one another.

10. The optical pickup head for optical recording media as recited in claim 1, further comprising a semiconductor module for emitting laser beams with different wavelengths compatible with different optical recording media to the diffracting element.

11. The optical pickup head for optical recording media as recited in claim 10, wherein the semiconductor module comprises a photo detector for receiving return laser beams and generating corresponding electrical signals.

12. An optical pickup head for optical recording media, comprising:
a semiconductor module for emitting a laser beam with a specified wavelength;
a diffracting element;
a reflective multi-surface prism;
a collimating lens;
an optical path changer; and
an objective lens adapted to face an optical recording medium;
wherein the laser beam emitted from the semiconductor module directly passes through the diffracting element and perpendicularly projects to an incident surface of the prism; the incident laser beam is reflected by at least one reflective surface of the prism and passes out from the prism through an emergent surface perpendicular to the incident surface of the prism; the emergent laser beam of the prism is condensed by the collimating lens and transformed into a parallel laser beam; a transmission direction of the parallel laser beam is deflected 90 degrees by the optical path changer and perpendicularly irradiates the objective lens; the laser beam is converged by the objective lens and forms a light spot on the optical recording medium; a corresponding return laser beam sequentially pass through/from the objective lens, the optical path changer, the collimating lens, the prism, and the diffracting element, and is received by the semiconductor module; the return laser beam being bent at a certain angle by the diffracting element.

13. The optical pickup head for optical recording media as recited in claim 12, wherein the prism is a pentagonal prism.

14. The optical pickup head for optical recording media as recited in claim 13, wherein the optical path changer is a reflecting mirror.

15. The optical pickup head for optical recording media as recited in claim 14, wherein an axis defined by the diffracting element and the incident surface of the pentagonal prism, an axis defined by the emergent surface of the pentagonal prism and the collimating lens, and an axis of the objective lens are all perpendicular to one another.

16. The optical pickup head for optical recording media as recited in claim 12, wherein the collimating lens is attached to the emergent surface of the prism.

17. An optical pickup head for optical recording media, comprising:
a laser source providing laser beams used for said optical recording media and emitted toward said optical recording media along a predetermined path;
a photo detector for receiving reflected laser beams from said optical recording media along said predetermined path;
a diffracting element disposed in said predetermined path for allowing said laser beams to directly pass through from said laser source toward said optical media, and to deflect said reflected laser beams from said optical recording media toward said photo detector;
a reflective multi-surface prism disposed between said diffracting element and said optical recording media in said predetermined patch, said prism including at least one reflective surface adapted to reflect said laser beams and said reflected laser beams in said prism;
a collimating lens disposed between said prism and said optical recording media in said predetermined path for transforming said laser beams and said reflected laser beams;
an optical path changer disposed between said collimating lens and said optical recording media in said predetermined path to guide said laser beams and said reflected laser beams in said predetermined path; and
an objective lens disposed between said optical path changer and said optical recording media in said predetermined patch, said objective lens adapted to converge said laser beams onto said optical recording media.

18. The optical pickup head as recited in claim 17, wherein said collimating lens is integrally formed with said prism.

19. The optical pickup head as recited in claim 17, wherein said optical path changer is a reflective mirror.

20. The optical pickup head as recited in claim 17, wherein a section of said predetermined path through said diffracting element, a section of said predetermined path through said collimating lens and a section of said predetermined path through said objective lens are perpendicular to one another respectively.
